(19) United States
(12) Patent Application Publication
(10) Pub. No.: US 2015/0073808 A1
(43) Pub. Date: Mar. 12, 2015

(54) REMOTE CONTROL AND PAYMENT TRANSACTIONING SYSTEM USING NATURAL LANGUAGE, VEHICLE INFORMATION, AND SPATIO-TEMPORAL CUES

(71) Applicant: IMS SOLUTIONS, INC., Schaumburg, IL (US)

(72) Inventors: Otman A. Basir, Waterloo (CA); David Neil Campbell, Oakville (CA); Bahador Khaleghi, Waterloo (CA); William Ben Miners, Guelph (CA); Eric Hartwell, Waterloo (CA)

(21) Appl. No.: 14/296,027

(22) Filed: Jun. 4, 2014

Related U.S. Application Data
(60) Provisional application No. 61/830,780, filed on Jun. 4, 2013.
(60) Provisional application No. 61/830,790, filed on Jun. 4, 2013.

(51) Int. Cl. G06Q 20/08; G06Q 10/02; G06Q 50/30; G10L 17/22

(52) U.S. Cl. CPC G06Q 20/08; G10L 17/22; G06Q 10/02; G06Q 50/30
USPC 704/275

(57) ABSTRACT

A system enables a mobile platform to issue commands using natural language dialog in order to control and/or monitor the functionality of remote systems according to a desired set of criteria and/or meta-criteria.

### BACKGROUND OF THE INVENTION

Modern telecommunication technologies allow persistent connectivity across a diverse spectrum of devices. Consequently, human users can potentially control and monitor the functionality of any properly configured device while operating through a mobile platform with wireless network connectivity.

Humans mainly rely on natural language dialog, visual cues and gestures, and touch to interact with the outside world whereas devices typically have their own particular modality of interaction specified as an interface. Accordingly, there is a need for intelligent intermediary systems that are able to comprehend both the communication modalities deployed by human users and those of device interfaces in order to bridge the existing communication gap and streamline natural human-machine interaction.

### SUMMARY OF THE INVENTION

The present invention provides a system to enable human users, who are operating through a wirelessly connected mobile platform, to readily interact with remote systems using a human-friendly communication modality such as natural language dialog, visual gestures, and/or touch.

The user can deploy commands to control and/or monitor the functionality of one or more remote systems. The input commands are inputted using natural language dialog, gestures, and/or touch, and forwarded to a remote server where they are adapted in form to comply with the interface specifications of the desired remote system. The outcome of a user command is retrieved from the target remote system interface and conveyed back to the user in a human-friendly form such as natural language voice.

In another, optional feature, the execution of inputted user commands may be triggered according to a set of criteria. These criteria may be temporal, spatial, or spatio-temporal in nature. In addition, they could be predefined, user-defined, and/or learned during system operation.

In yet another, optional feature, the execution of inputted user commands may be triggered according to a set of meta-criteria. These meta-criteria are obtained by observing predefined and/or user-defined patterns within a set of meta-data regarding historical user activities such as frequency, popularity, or priority of a issuing a command, visiting a place, or deploying a criterion.

In the disclosed system, one or more commands can be used to request an action or elicit/sense information regarding one or more remote systems. Optionally, two or more commands can be executed in sequence or in parallel as per user and/or application preferences. Optionally, one or more commands can be targeted at two or more remote systems simultaneously.

The commands may be triggered according to one or more predefined, user-defined, and/or learned criteria. The criteria may be temporal criteria. The criteria may be spatial criteria (e.g. “near home,” “near the office,” “near a particular parking lot,” etc). The criteria may be spatio-temporal criteria. The criteria may be socially-motivated criteria. The temporal criteria include, but are not restricted to, one or more events in a user calendar and/or schedule.

The spatial criteria may include one or more places commonly visited by a user. The spatial criteria may include one or more places on a map. The spatio-temporal criteria involve both events and places. socially-motivated criteria include those according to spatial, temporal, spatio-temporal, and/or learned criteria adopted from one or more of a user's friends in a social network community of users. The socially-motivated criteria may be shared, inherited, and transferred among friends in a social network community of users.

Learned criteria include those adopted according to historical user activity meta-data such as frequency, priority, and popularity of issuing a command or deploying a criterion. The commands may be triggered according to one or more learned meta-criteria. The meta-criteria are adopted according to predefined and/or user-defined patterns observed within learned meta-data.

The computing platform interacts with a remote payment system and performs an electronic payment transaction.

A multi-factor authentication process is included as part of the transaction. This authentication process may include the location of the computing platform relative to the vehicle and proximity of the payment recipient. The payment transaction is automatically verified or completed only after user verification as specified in user preferences. User preferences include rules based on payment amount, location, time of day, and payment recipient. This allows the user to automatically pay for parking without intervention or consuming valuable time every time the driver parks.

The status of the transaction is monitored and the user is updated with the transaction process, and a receipt is delivered to the user. The authentication step can deploy biometrics cues including voice, fingerprint, palm print, and face recognition, password, or PIN.

Providing payment information can include supplying user credit card, debit card, and store-specific card data. The computing platform may interoperate with a payment network of one or more service providers. A report of historical payment transactions performed through the computing platform may be produced periodically or on-demand and provided to the user. The report may include individual transaction information and/or overall transaction statistics. The vehicle can be used to deposit and withdrawal money into the vehicle itself, enabling the vehicle to be treated as a virtual wallet.

### BRIEF DESCRIPTION OF THE DRAWINGS

FIG. 1 schematically illustrates the block diagram architecture of a preferred embodiment of the disclosed system 10.

### DETAILED DESCRIPTION OF THE PREFERRED EMBODIMENT

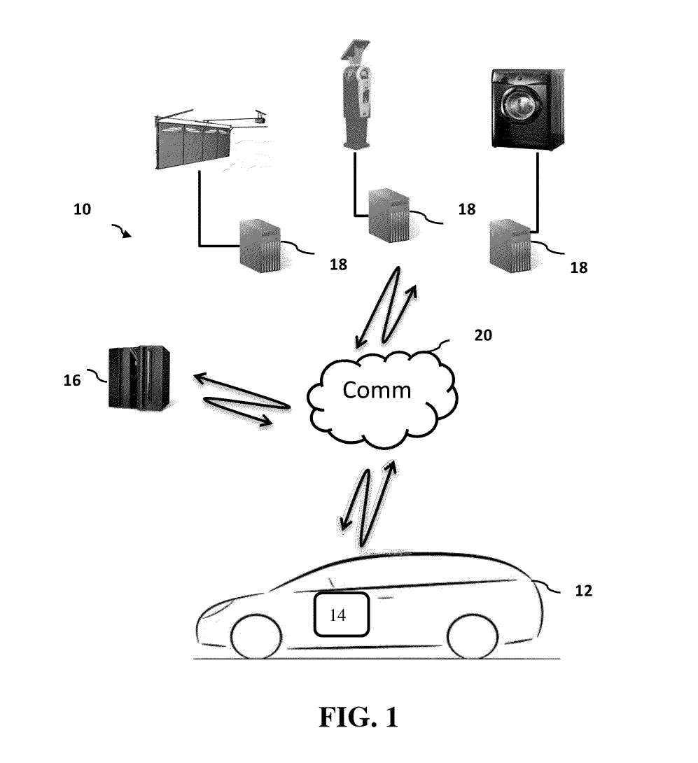

Referring to FIG. 1, a preferred embedment of the disclosed system 10 includes a brought-in and/or built-in mobile device 14, situated inside a vehicle 12. If brought-in, the mobile device 14 could be a cell phone, smart phone, super phone, laptop, or a tablet. The mobile device 14 is wirelessly connected to a remote server 16 through a communication network 20. The disclosed system 10 further includes one or more remote system interfaces 18 that are connected to the remote server 16 through wireless communication network 20.

As examples, one of the remote system interfaces 18 is connected to a garage door opener, one is connected to a parking payment station and one is connected to a home appliance (e.g. washer, dryer, iron, television, oven, lights, hvac, etc). The remote system interfaces 18 can retrieve information from the connected device (such as operating status information or cost information) and transmit information to the connected device (such as a command or payment information).

A user issues one or commands using natural language dialog on the mobile platform 14. The inputted user commands are converted into textual data using a local speech to text engine operating on the mobile device 14. The obtained textual representation of user commands is then forwarded to the remote server 16 through the wireless network 20. Alternatively, the raw user commands are directly forwarded to the remote server 16 to be processed by a remote speech to text engine.

Alternatively, instead of vocal/speech commands, the user can use visible gestures, such as hand gestures, to issue commands. For example, gestures can include pointing at an object or a closed fist. A closed fist (for example) can be programmed to mean “close the garage door.”

Commands can be used to request status of devices connected to the remote system interfaces 18. For example, the user can ask, “is the iron on?” or “check if the garage is open” or “are the lights on?”

Commands can be used in combination, such as, “turn off the lights and close the garage door” or in sequence such as “turn off the lights and then close the garage door.”

Depending on the specific remote server interface 18 targeted by the user, the remote server 16 then adapts the textual representation of user command to the form appropriate for the remote interface. For instance, in case of remote garage door opener interface the operating status of the garage door opener (e.g. open or closed) can be reported back to the user and the user command is converted into corresponding control instructions of electric motor of the garage door opener system. Similarly, to interact with an automatic parking payment system, the cost information may be reported back to the user and the user commands are converted into corresponding instructions to perform an electronic payment transaction. For a home appliance, the remote server interface may report back operating status (e.g. on/off) and the user command may change the operating status.

The results of the submitted user commands are retrieved from the targeted user interface 18 and communicated back to the remote server 16. The remote server then converts the obtained results data into their corresponding natural language form and forwards those back to the mobile platform 14 through the wireless network 20. Lastly, the mobile platform 14 communicates the outcome of the user command(s) back to the user using a voice interface.

The user commands can be associated with a set of criteria and be deployed only if the corresponding criteria are realized. These criteria can be of various types including spatial, temporal, and/or spatio-temporal. For instance, the user can issue a command to activate his/her garage door opener, which is deployed only if the mobile platform 14 is within a close vicinity of user's home. These criteria can be built into the system, i.e. predefined, or inputted by the user, i.e. user-defined. They can also be learned by the disclosed system 10 through observing the history of user commands over time.

The user commands can be associated with a set of meta-criteria and be deployed only if the corresponding meta-criteria are realized. Similar to the regular criteria, the meta-criteria are defined based on spatial, temporal, and/or spatio-temporal constraints. However, instead of operating on directly accessible data, such as location of the mobile platform 14 or the time of the day, they operate on meta-data, which are deduced by identifying predefined and/or user-defined patterns within a historical record of directly accessible data. For instance, by monitoring the recent history of places visited by a user, the disclosed system 10 can identify a frequently visited parking lot and invite user to issue an automated parking payment command, if desired.

In another feature of the proposed system 10, the vehicle 12 authenticates and provides access to the vehicle 12 (e.g. such as locking and unlocking the doors) based on the proximity of an authorized user and a set of access rules. Alternatively, access to a container other than a vehicle 12 could be controlled. The authorized user may be identified by the vehicle recognizing the presence of the user's mobile device 14. The authorized user is registered with the vehicle 12 using direct point-to-point RF communication including but not limited to: Passive RFID, active RFID, Bluetooth, WiFi. Alternatively, a passive RFID reader is connected to the vehicle 12, and a RFID tag is part of a device 14 carried by the authorized user.

As another alternative, a passive RFID reader is part of a device 14 carried by the authorized user (i.e. a mobile phone with a passive RFID reader), and a RFID tag is part of the container. The system 10 can be configured to reuse existing RFID tags, including but not limited to a credit card, identity card, keyfob for building access, or other unique identifier.

The access rules can be linked to a reservation schedule to provide controlled access to multiple potential users of the same vehicle 12 with predetermined time windows, in which case the current time (including current date) would be compared to the reservation schedule to determine if the user associated with the device 14 is authorized to access the vehicle 12 at this time. The access rules can be adjusted from a remote server 16 and locally cached to ensure vehicle 12 access rules are applied even without communication to a remote server 16. The authorized user is registered with the vehicle 12 using visual cues including but not limited to: Barcode, VIN reader, QR code, or license plate images. Access includes unlocking a door, honking the horn, checking the vehicle health, and locating the vehicle remotely.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope.

What is claimed is:

1. A method for controlling and/or monitoring the functionality of remote systems including the steps of:
a) receiving a user command on a mobile device from a user;
b) processing the user command to convert the user command to a system command; and
c) sending the system command to a remote system for execution by the remote system.

2. The method of claim 1 wherein the user command received by the mobile device is speech.

3. The method of claim 2 wherein the user command is converted to the system command on the mobile device.

4. The method of claim 3 wherein the mobile device is a cell phone.

5. The method of claim 1 wherein the remote system controls a garage door opener.

6. The method of claim 1 wherein the remote system controls a home appliance.

7. The method of claim 1 wherein the remote system controls a parking payment station.

8. The method of claim 7 wherein the system command effects a payment to the parking payment station.

9. The method of claim 1 wherein the system command is in a text format.

10. The method of claim 1 further including the step of: d) evaluating criteria associated with the user and wherein said step c) is performed based upon said step d).

11. The method of claim 10 wherein the criteria depend upon a current location of the mobile device.

12. The method of claim 10 wherein the criteria are created automatically based upon a history of user commands.

13. The method of claim 10 wherein the criteria depend upon a current time.

14. The method of claim 1 wherein the user command is one of a plurality of user commands, said step a) including receiving the plurality of user commands in a single spoken speech.

15. The method of claim 14 wherein the system command is one of a plurality of system commands and the remote system is one of a plurality of remote systems and wherein the plurality of user commands are converted to the plurality of system commands in said step b) and wherein said step c) includes sending the plurality of system commands to the plurality of remote systems.

16. A method of providing access to a vehicle including the steps of:
a) determining a presence of a mobile device proximate the vehicle;
b) determining whether the mobile device is associated with an authorized user of the vehicle; and
c) based upon said step b), providing access to the vehicle.

17. The method of claim 16 wherein said step b) further includes the step of comparing a current time to a reservation schedule and wherein said step c) is also based upon the comparison to the reservation schedule.

18. The method of claim 17 wherein the reservation schedule is cached on the vehicle.
